(19) United States
(12) Patent Application Publication
(10) Pub. No.: US 2022/0397529 A1
(43) Pub. Date: Dec. 15, 2022

(54) OBSERVATION DEVICE, REFLECTOR, AND PHASE OBJECT OBSERVATION METHOD

(71) Applicant: OLYMPUS CORPORATION, Tokyo (JP)

(72) Inventor: Tadashi HIRATA, Tokyo (JP)

(73) Assignee: OLYMPUS CORPORATION, Tokyo (JP)

(21) Appl. No.: 17/679,401

(22) Filed: Feb. 24, 2022

(30) Foreign Application Priority Data
Jun. 10, 2021 (JP) 2021-097451

(51) Int. Cl. G01N 21/64; G02B 21/06; G02B 21/26

(52) U.S. Cl. CPC G01N 21/6452; G02B 21/06; G02B 21/26

(57) ABSTRACT

An observation device includes an illumination optical system provided on a lower side of an installation position of a multi-well plate, a reflector that reflects light emitted from the illumination optical system, the reflector being provided on an upper side of the installation position, and an observation optical system that condenses the light reflected by the reflector, the observation optical system being provided on the lower side of the installation position. The reflector includes a plurality of curved surfaces where the light emitted from the illumination optical system enters. Each of the plurality of curved surfaces corresponds to one or more wells included in the multi-well plate, has positive power in a first direction in which the illumination optical system and the observation optical system are aligned, and has a center of curvature at a position deviating from a central axis of a well of the multi-well plate.

### CROSS REFERENCE TO RELATED APPLICATIONS

This application is based upon and claims the benefit of priority from prior Japanese Patent Application No. 2021-097451, filed Jun. 10, 2021, the entire contents of which are incorporated herein by this reference.

### TECHNICAL FIELD

The disclosure of the present specification relates to an observation device, a reflector, and a phase object observation method.

### BACKGROUND

Culture of a biological sample such as a cell is performed in an incubator to maintain a culture environment. A state of the biological sample is regularly confirmed during the culture. However, taking out the biological sample from the incubator each time of confirmation work may cause a harmful effect on the growth of the biological sample.

A technique related to such a problem is described in, for example, U.S. Patent Application Publication No. 2019/0187450. Using an observation device in which oblique illumination is adopted described in U.S. Patent Application Publication No. 2019/0187450 makes it possible to observe a sample such as a cell without increasing the size of the device. Thus, it becomes possible to continuously observe a biological sample during culture in a limited space in an incubator without taking out the biological sample during culture from the incubator.

### SUMMARY

An observation device according to an aspect of the present invention includes an illumination optical system provided on a lower side of an installation position of a multi-well plate, a reflector that reflects light emitted from the illumination optical system, the reflector being provided on an upper side of the installation position, and an observation optical system that condenses the light reflected by the reflector, the observation optical system being provided on the lower side of the installation position, in which the reflector includes a plurality of curved surfaces where the light emitted from the illumination optical system enters, in which each of the plurality of curved surfaces, corresponds to one or more wells included in the multi-well plate, has positive power in a first direction in which the illumination optical system and the observation optical system are aligned, and has a center of curvature at a position deviating from a central axis of the well of the multi-well plate.

A reflector according to an aspect of the present invention attached to a multi-well plate, includes a positioning structure that positions the reflector placed so as to cover an upper surface of the multi-well plate to a predetermined position with respect to the multi-well plate, and a plurality of curved surfaces where light from the multi-well plate enters, in which each of the plurality of curved surfaces, is configured to correspond to one or more wells included in the multi-well plate, has positive power, and has a center of curvature at a position deviating from any of centers of the corresponding one or more wells.

A method for observing a phase object contained in a multi-well plate according to an aspect of the present invention includes emitting light from an illumination optical system provided on a lower side of an installation position of the multi-well plate, reflecting the light emitted from the illumination optical system by a reflector provided on an upper side of the installation position, and the light reflected by the reflector by an observation optical system provided on the lower side of the installation position. The reflector has a plurality of curved surfaces where the light emitted from the illumination optical system enters, in which each of the plurality of curved surfaces, corresponds to one or more wells included in the multi-well plate, has positive power in a first direction in which the illumination optical system and the observation optical system are aligned, and has a center of curvature at a position deviating from a central axis of a well of the multi-well plate.

### BRIEF DESCRIPTION OF DRAWINGS

The present invention will be more apparent from the following detailed description when the accompanying drawings are referenced.

FIG. 1 is a diagram illustrating an example of a configuration of a system;

FIG. 2 is a perspective view of an observation device;

FIG. 3 is a plan view of a multi-well plate;

FIG. 4 is a diagram illustrating a configuration of the observation device;

FIG. 5 is a diagram illustrating an example of a configuration of a light source unit and an image capturing unit;

FIG. 6 is a diagram illustrating an example of a configuration of a control device;

FIG. 7 is a perspective view of a reflector;

FIG. 8 is a diagram illustrating a state in which the reflector is attached to the multi-well plate;

FIG. 9 is a sectional view of a reflector according to a first embodiment;

FIG. 10 is a diagram describing a positional relationship of the reflector and the multi-well plate;

FIG. 11 is a sectional view of an observation device according to the first embodiment;

FIG. 12 is a sectional view of a reflector according to a second embodiment;

FIG. 13 is a diagram describing a positional relationship of the reflector and the multi-well plate;

FIG. 14 is a sectional view of an observation device according to the second embodiment;

FIG. 15 is a diagram describing a positional relationship of a reflector according to a third embodiment and a multi-well plate;

FIG. 16 is a diagram describing a positional relationship of the center of a well and the center of curvature of a curved surface corresponding to the well;

FIG. 17 is a sectional view of a reflector according to a fourth embodiment;

FIG. 18 is a sectional view of an observation device according to the fourth embodiment;

FIG. 19 is a sectional view of a reflector according to a fifth embodiment;

FIG. 20 is a sectional view of an observation device according to the fifth embodiment;

FIG. 21 is a sectional view of a reflector according to a sixth embodiment; and

FIG. 22 is a sectional view of an observation device according to the sixth embodiment.

### DESCRIPTION OF EMBODIMENTS

When a multi-well plate, in particular, a multi-well plate having a small well diameter such as, for example, a 96-well plate, is used as a culture vessel, it is difficult to obtain high observation performance by the oblique illumination used in the observation device described above.

Considering such circumstances, an embodiment of the present invention will be described hereinafter.

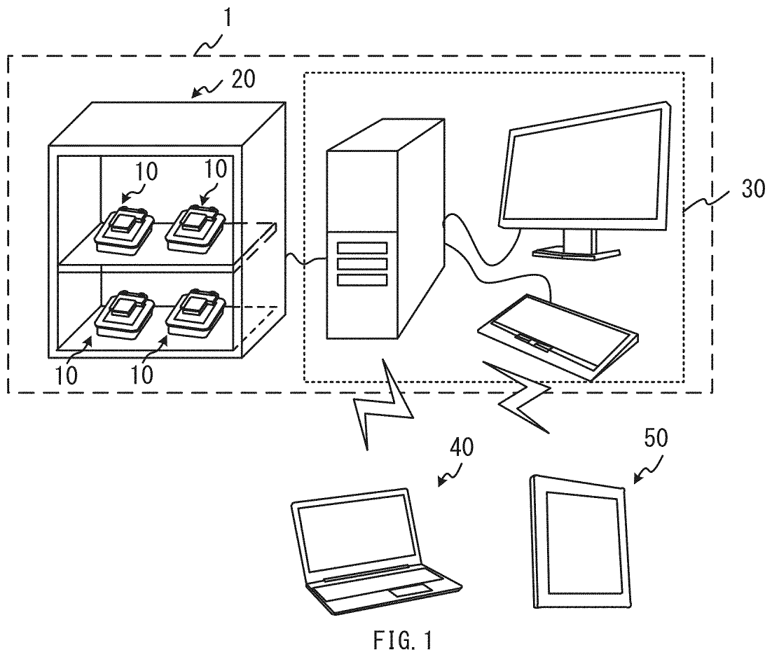

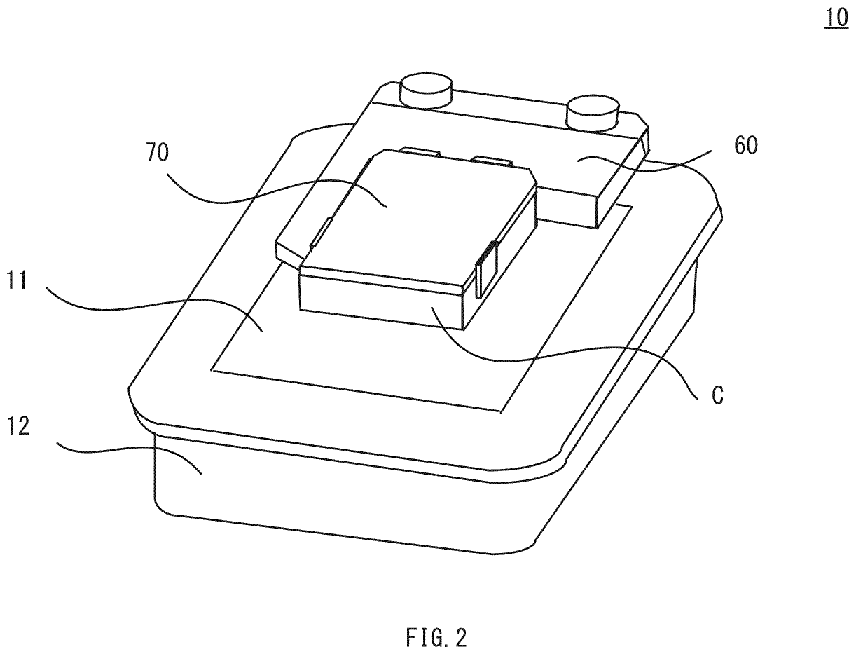

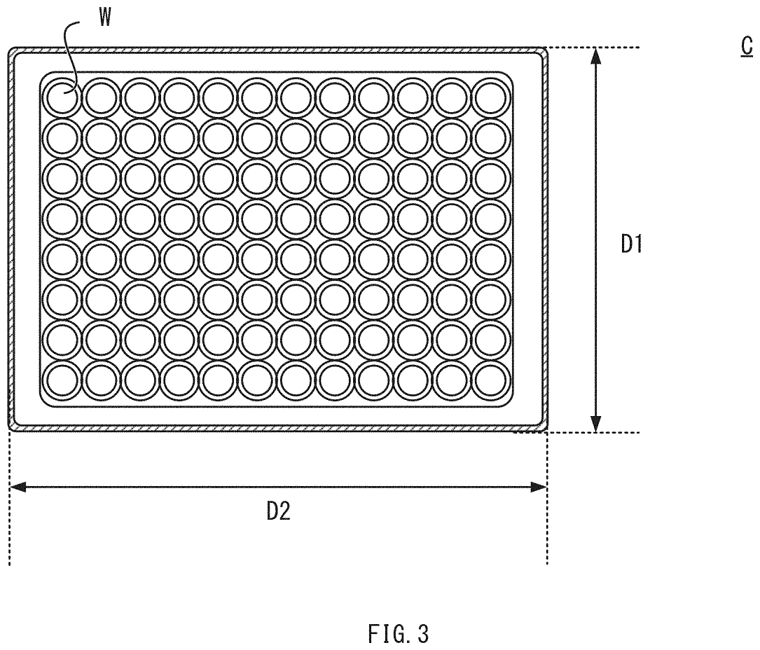

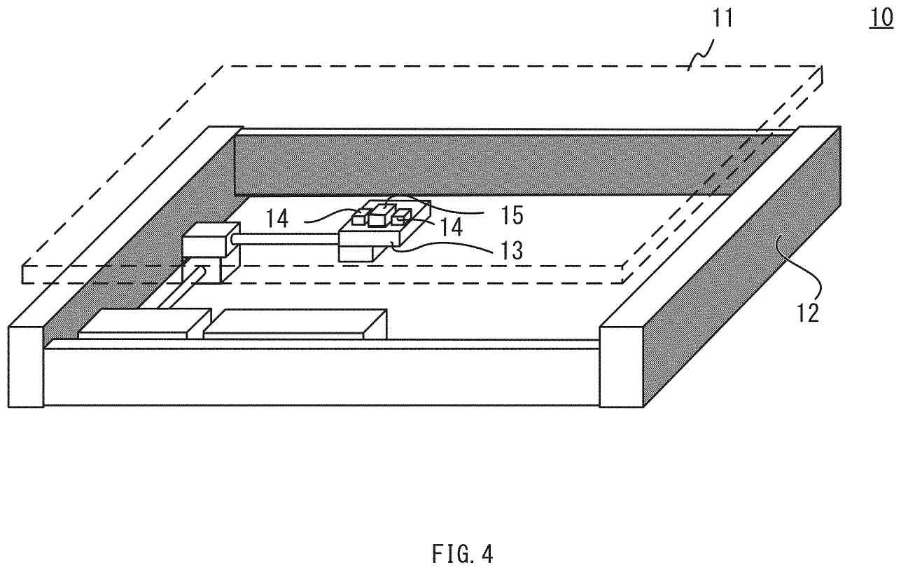

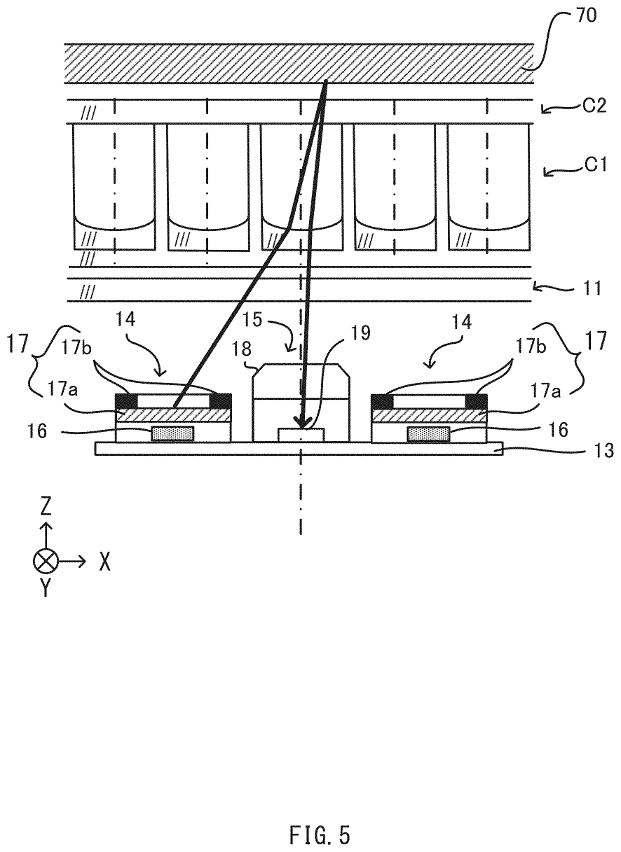

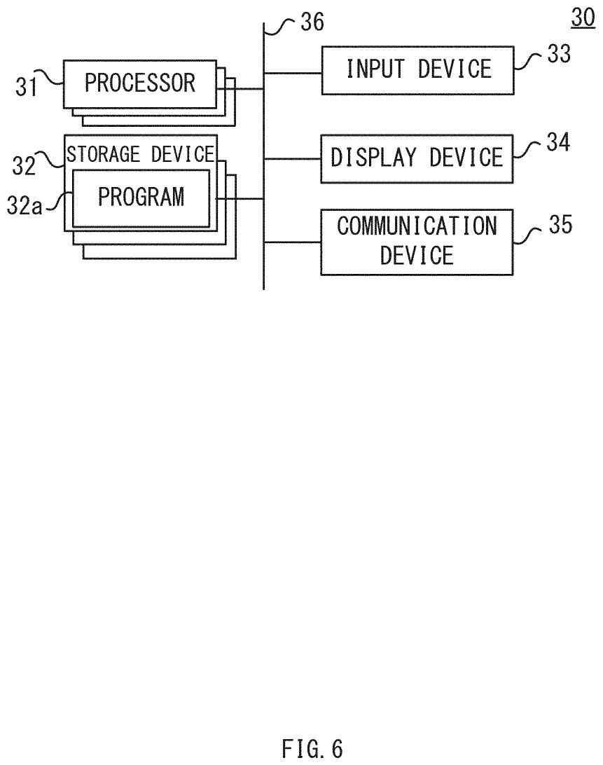

FIG. 1 is a diagram illustrating an example of a configuration of a system; FIG. 2 is a perspective view of an observation device; FIG. 3 is a plan view of a multi-well plate; FIG. 4 is a diagram illustrating a configuration of the observation device; FIG. 5 is a diagram illustrating an example of a configuration of a light source unit and an image capturing unit; FIG. 6 is a diagram illustrating an example of a configuration of a control device; Hereinafter, the configuration of the system 1 will be described with reference to FIG. 1 to FIG. 6.

The system 1 shown in FIG. 1 is an observation system for observing a sample contained in a multi-well plate while being cultured. The sample to be observed is any culture cell, and examples thereof include a colorless and transparent phase object. The well number of the multi-well plate is not particularly limited. However, hereinafter, an example of using a 96-well plate will be described.

The system 1 includes one or more observation devices 10 which acquire an image of the sample cultured in the multi-well plate and a control device 30 which controls the observation devices 10. Data need to be exchanged between each of the observation devices 10 and the control device 30. Thus, each of the observation devices 10 and the control device 30 are communicably connected with a wire as shown in FIG. 1 or wirelessly.

The observation device 10 is an imaging capturing device which captures an image of a sample contained in the multi-well plate from a lower side of the multi-well plate. An image of the sample is captured without taking out the sample from an incubator 20. Thus, for example, as shown in FIG. 1, the observation device 10 is used in a state of being disposed in the incubator 20. More specifically, as shone in FIG. 2, the observation device 10 is disposed in the incubator 20 such that the multi-well plate C is placed on a transmission window 11 of the observation device 10 to acquire an image of the sample contained in a well of the multi-well plate C according to an instruction from the control device 30.

As shown in FIG. 2, the observation device 10 includes a box-shaped case 12 having the transparent transmission window 11 on which the multi-well plate C is placed as an upper surface, a positioning member 60 which positions the multi-well plate C to a predetermined position with respect to the observation device 10 on the transmission window 11 (a placing surface), and a reflector 70 attached to the multi-well plate C.

The transmission window 11 provided to the case 12 is a transparent top plate which constitutes an upper surface of the case 12 of the observation device 10 and constitutes the placing surface on which the multi-well plate C is placed. That is, in the observation device 10, the position on the transmission window 11 serves as the installation position of the multi-well plate C. The transmission window 11 is made of, for example, glass or a transparent resin.

The positioning member 60 is fixed to the case 12. However, the positioning member 60 can be removed as needed.

As shown in FIG. 2, the reflector 70 attached to the multi-well plate C is provided on an upper side of the installation position of the multi-well plate C. When the observation device 10 captures an image of the sample from a lower side of the multi-well plate C, the reflector 70 reflects light emitted from an illumination optical system 17 described below, that is, light from the multi-well plate C.

Note that, as shown in FIG. 3, the multi-well plate C includes, for example, 96 (=12×8) wells W. Width (width D1 and D2) in a vertical direction and a lateral direction of the multi-well plate C is predetermined by, for example, ANSI/SBS Standard.

As shown in FIG. 4 and FIG. 5, the observation device 10 further includes a stage 13 which moves in the case 12, a pair of light source units 14 which illuminate the sample contained in the multi-well plate C, and an image capturing unit 15 which acquires an image of the sample. The stage 13, the light source units 14, and the image capturing unit 15 are housed in the case 12. The light source units 14 and the image capturing unit 15 are disposed on the stage 13 and move with respect to the multi-well plate C when the stage 13 is moved in the case 12.

The stage 13 is an example of a moving unit which moves in the observation device 10 and changes a relative position of the image capturing unit 15 with respect to the multi-well plate C. The stage 13 can move in an X direction and a Y direction which are parallel to the transmission window 11 (the placing surface) and are orthogonal to each other. Note that the stage 13 may also move in a Z direction which is orthogonal to both the X direction and the Y direction.

Note that FIG. 4 and FIG. 5 show an example in which the light source units 14 and the image capturing unit 15 are disposed on the stage 13, and, as a result, they move together in the case 12. However, the light source units 14 and the image capturing unit 15 may move independently in the case 12. Further, FIG. 4 and FIG. 5 show an example in which the pair of the light source units 14 are disposed on the left and right of the image capturing unit 15. However, the arrangement and the number of the light source units 14 are not limited to this example. For example, three or more light source units 14 may be disposed on the stage 13, or only one light source unit 14 may be disposed.

As shown in FIG. 5, the light source unit 14 includes a light source 16 and the illumination optical system 17. The light source 16 includes, for example, a light-emitting diode (LED). The light source 16 may include a white LED or a plurality of LEDs which emit light of a plurality of different wavelengths, such as R (red), G (green), and B (blue). The light emitted from the light source 16 enters the illumination optical system 17.

As shown in FIG. 5, the illumination optical system 17 is provided on the lower side of the installation position (i.e., the upper surface of the transmission window 11) of the multi-well plate C and emits the light emitted from the light source 16 toward the multi-well plate C from the lower side of the multi-well plate C.

The illumination optical system 17 includes a diffusion plate 17a and a mask 17b. The diffusion plate 17a diffuses the light emitted from the light source 16. The diffusion plate 17a is not particular limited. However, for example, the diffusion plate 17a is a frosted diffusion plate having uneven portions formed on its surface. Note that the diffusion plate 17a may be an opal diffusion plate of which a surface is coated or other types of diffusion plates. Further, the mask 17b attached to the diffusion plate 17a limits an emission region of the diffused light. The light emitted from the diffusion plate 17a travels in various directions and enters the well at various angles.

As shown in FIG. 5, the image capturing unit 15 includes an observation optical system 18 and an imaging element 19. The observation optical system 18 is provided on the lower side of the installation position of the multi-well plate C and condenses the light which is transmitted through the transmission window 11 and enters the case 12. More specifically, the observation optical system 18 condenses the light from a bottom surface of the well W where the sample exists on the imaging element 19 and thereby forms an optical image of the sample on the imaging element 19.

The imaging element 19 is a photosensor which converts detected light to an electric signal. The imaging element 19 is an image sensor, and examples thereof include a CCD (charge-coupled device) image sensor and a CMOS (complementary MOS) image sensor without being particularly limited thereto.

The observation device 10 configured as described above adopts oblique illumination to visualize the sample which is a phase object. Specifically, as shown in FIG. 5, the light emitted by the light source 16 is diffused by the diffusion plate 17a, transmitted through the transmission window 11, and emitted to the outside of the case 12. That is, the illumination optical system 17 of the light source unit 14 emits the light which travels to the outside of the case 12 in various directions. Subsequently, a part of the light emitted to the outside of the case 12 is reflected by, for example, a liquid interface in the well W, a lid C2 put on a vessel body C1 of the multi-well plate C, and the reflector 70 attached to the multi-well plate C, and thus deflected on an upper side of the sample. Further, a part of the light deflected on the upper side of the sample irradiates the sample and then enters the case 12 after being transmitted through the sample and the transmission window 11. Then, a part of the light entering the case 12 is condensed by the observation optical system 18 to form an image of the sample on the imaging element 19. That is, the observation optical system 18 condenses the light reflected by the liquid interface in the well W, condenses the light reflected by the C2 of the multi-well plate C, and condenses the light reflected by the reflector 70 attached to the multi-well plate C. As a result, the observation optical system 18 forms an optical image of the sample on the imaging element 19. Finally, the observation device 10 generates an image of the sample on the basis of the electric signal outputted from the imaging element 19 and outputs it to the control device 30.

The control device 30 is a device which controls the observation device 10. Specifically, the control device 30 controls the stage 13 as a moving unit, the light source units 14, and the image capturing unit 15. Note that the control device 30 is only required to include one or more processors and one or more non-transitory computer readable media. For example, the control device 30 may be a general computer.

More specifically, the control device 30 includes, for example, as shown in FIG. 6, one or more processors 31, one or more storage devices 32, an input device 33, a display device 34, and a communication device 35, and they are connected via a bus 36.

Each of the one or more processors 31 is a piece of hardware including, for example, a CPU (central processing unit), a GPU (graphics processing unit), and a DSP (digital signal processor) and performs a programmed process by executing a program 32a stored in the one or more storage devices 32. Further, the one or more processors 31 may include an ASIC (application specific integrated circuit), an FPGA (field-programmable gate array), and the like.

Each of the one or more storage devices 32 may include, for example, any one or more of semiconductor memories and also include one or more of other storage devices. The semiconductor memory may include, for example, a volatile memory such as a RAM (random access memory) and a non-volatile memory such as a ROM (read only memory), a programmable ROM, or a flash memory. The RAM may include, for example, a DRAM (dynamic random access memory) and an SRAM (static random access memory). Other storage devices may include, for example, a magnetic storage device including a magnetic disk and an optical storage device including an optical disk. Note that the one or more storage devices 32 are non-transitory computer readable media.

The input device 33 is a device directly operated by a user. Examples thereof include a keyboard, a mouse, and a touch panel. Examples of the display device 34 include a liquid crystal display, an organic EL display, and a CRT (cathode ray tube) display. The display may include a built-in touch panel. The communication device 35 may be a wired communication module or a wireless communication module.

Note that the configuration shown in FIG. 6 is an example of the hardware configuration of the control device 30, and the control device 30 is not limited to this configuration. The control device 30 is not limited to a general-purpose device and may be a dedicated device.

The control device 30 configured as described above sends an image acquisition instruction to the observation device 10 placed in the incubator 20 and receives an image acquired by the observation device 10. The control device 30 may display the image acquired by the observation device 10 on the display device 34 included in the control device 30. In this manner, the system 1 may function as an observation system for the user to observe the sample during culture. Note that the control device 30 may communicate with a client terminal (a client terminal 40 and a client terminal 50) shown in FIG. 1 and display the image acquired by the observation device 10 on a display device included in the client terminal. The client terminal is only required to include a display portion, and examples thereof may include desktop and notebook computers, a tablet, and a smartphone.

In order to visualize the sample as a phase object with high contrast and recognize a cell or the like, it is important to form an image of the sample by condensing the light having entered the sample at a proper angle, that is, establishing oblique illumination. Specifically, the light having entered the sample desirably includes light having an incident angle larger than an angle corresponding to the numerical aperture of the observation optical system 18 and light having an incident angle smaller than such an angle.

The reason for this can be explained as follows. An incident angle to an object plane is converted to a distance from an optical axis on a pupil plane of the observation optical system 18 by the observation optical system 18. Thus, a bundle of light rays having the incident angles on the object plane widely distributed in relatively large angles satisfying the above conditions is distributed across an outer edge of a pupil of the observation optical system 18 on the pupil plane. Among the bundle of light rays, the light rays entering the outside of the pupil (i.e., the light having the incident angle larger than the angle corresponding to the numerical aperture on the object plane) are vignetted in the observation optical system 18 and do not reach the imaging element 19. Thus, the bundle of the light rays reaching the imaging element 19 causes a discontinuous intensity distribution in the angle direction, that is, a sharp change in the intensity distribution, on an imaging plane. As a result, shading is formed on the image of the sample, making it possible to obtain a three-dimensional image with high contrast.

In the observation device 10, the sample in the well W is observed by guiding the light, which is emitted from the illumination optical system 17 and made incident to the multi-well plate C from the bottom surface of the given well W, to the observation optical system 18 from the bottom surface of the same well W. That is, in the case of using the multi-well plate C, an incident region to the multi-well plate C and an emission region from the multi-well plate C are limited to a narrow region as small as the well diameter.

Thus, in the case where the culture vessel is the multi-well plate C, it is not easy to cause the light to enter the object plane at the proper angle described above and then guide the incident light to the observation optical system 18. The well diameter becomes smaller as the well number increases. Thus, this becomes particularly difficult when a multi-well plate having a large number of wells such as, for example, 96 wells is used. Further, even if the oblique illumination can be achieved, the incident angle range of the light which can be guided to the observation optical system 18 significantly varies depending on a position in the well W in a conventional observation device. This increases a variation in brightness in the well and limits a region where high contrast can be achieved to a very limited range in the well. That is, it is difficult to achieve high observation performance in the observation of the phase object contained in the multi-well plate in the conventional observation device.

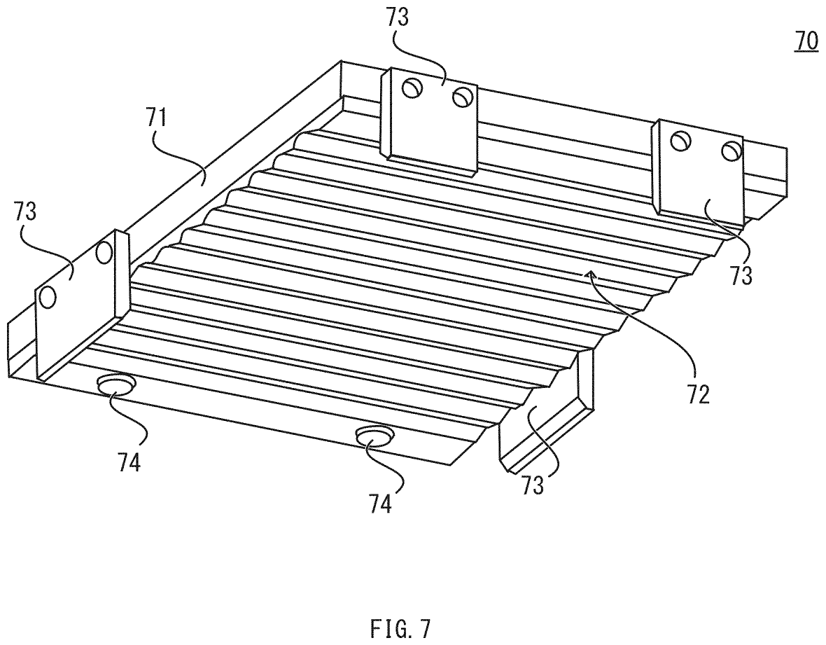

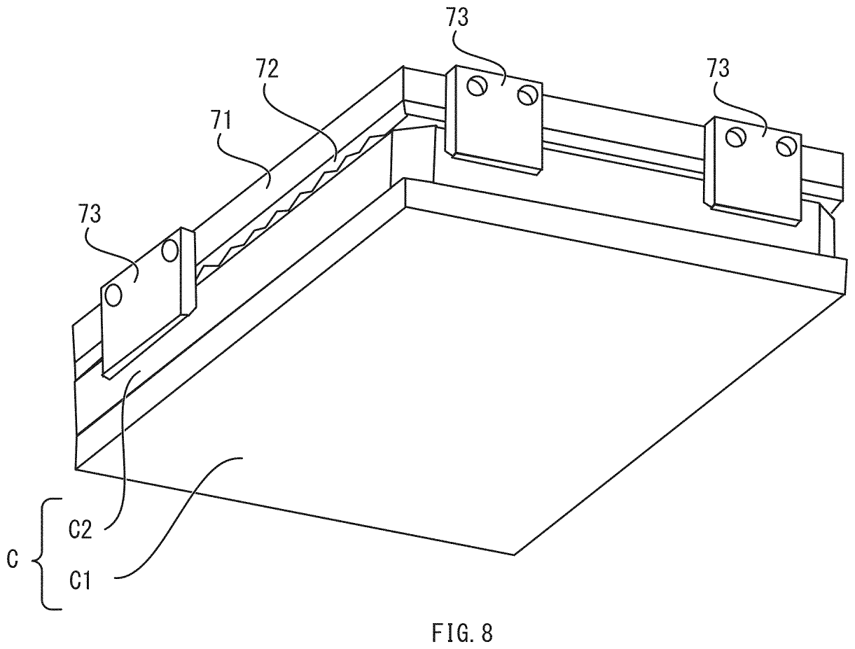

The observation device 10 solves such a problem in the conventional observation device by the reflector 70 attached to the multi-well plate C. FIG. 7 is a perspective view of a reflector; FIG. 8 is a diagram illustrating a state in which the reflector is attached to the multi-well plate; Hereinafter, the reflector 70 and the action thereof will be described with reference to FIG. 7 and FIG. 8.

As shown in FIG. 7, the reflector 70 includes a base 71 and an optical element 72 fixed to a bottom surface of the base 71. The reflector 70 may further include a positioning member 73 and a contact member 74.

A plurality of curved surfaces where the light from the multi-well plate C enters are formed in the optical element 72. That is, the light emitted from the illumination optical system 17 enters the plurality of curved surfaces. Note that each of the plurality of curved surfaces corresponds to the one or more wells W (e.g., a well row) included in the multi-well plate C and has positive power.

The reflector 70 converges or reduces divergence of the light from the multi-well plate C by using the positive power provided by the curved surface, thereby expanding a region where the oblique illumination is established in the well W. More specifically, a liquid interface in the well W has, for example, as shown in FIG. 5, a concave shape by surface tension. However, a diverging effect caused by negative power provided by the liquid interface can be cancelled by the positive power provided by the curved surface of the optical element 72. This can reduce the difference in the incident angle range depending on the position in the well, making it possible to expand the region where the oblique illumination is established as compared with the conventional observation device. Thus, the observation device 10 makes it possible to observe the sample as a phase object in a wider range and with better contrast than before.

Further, each of the plurality of curved surfaces has the center of curvature at a position deviating from a central axis WC of the well, more specifically, all of the centers (the well central axes) of the one or more wells corresponding to the curved surface. When the center of curvature is deviated from the central axis WC of the well, an average incident angle of the bundle of light rays passing through each point on the object plane (the well bottom surface) can be increased. This makes it possible to expand the region where the oblique illumination is established as compared with the conventional observation device. Thus, the observation device 10 makes it possible to observe the sample as a phase object in a wider range and with better contrast than before.

The positioning member 73 is an example of a positioning structure by which the reflector 70 is positioned at a predetermined position with respect to the multi-well plate C. As shown in FIG. 8, the reflector 70 which is placed so as to cover an upper surface of the multi-well plate C is positioned at the predetermined position with respect to the multi-well plate C by the positioning member 73. This allows the curved surfaces of the optical element 72 to be accurately arranged with respect to the wells W, so that the reflector 70 can exhibit previously designed effects.

The contact member 74 is a member which comes into contact with the lid C2 of the multi-well plate C and disposed on the surface of the optical element 72. The contact member 74 protruding from the surface of the optical element 72 comes into contact with the lid C2 put on the vessel body C1, so that the surface of the optical element 72 can be avoided from being in contact with the multi-well plate C. This can prevent a damage or the like to the optical element 72. Further, the contact member 74 also plays a role in keeping a distance from the bottom surface of the well W to the curved surface formed in the optical element 72 at a predetermined distance.

Attaching the reflector 70 configured as described above to the multi-well plate C makes it possible to reduce a variation in brightness in the well and widely obtain the region where high contrast can be achieved in the well. Thus, according to the observation device 10 including the reflector 70, it becomes possible to achieve the higher observation performance in the observation of the phase object contained in the multi-well plate as compared with the conventional observation device.

Hereinafter, specific examples of the configuration of the reflector 70 will be described in a first embodiment to a sixth embodiment.

### First Embodiment

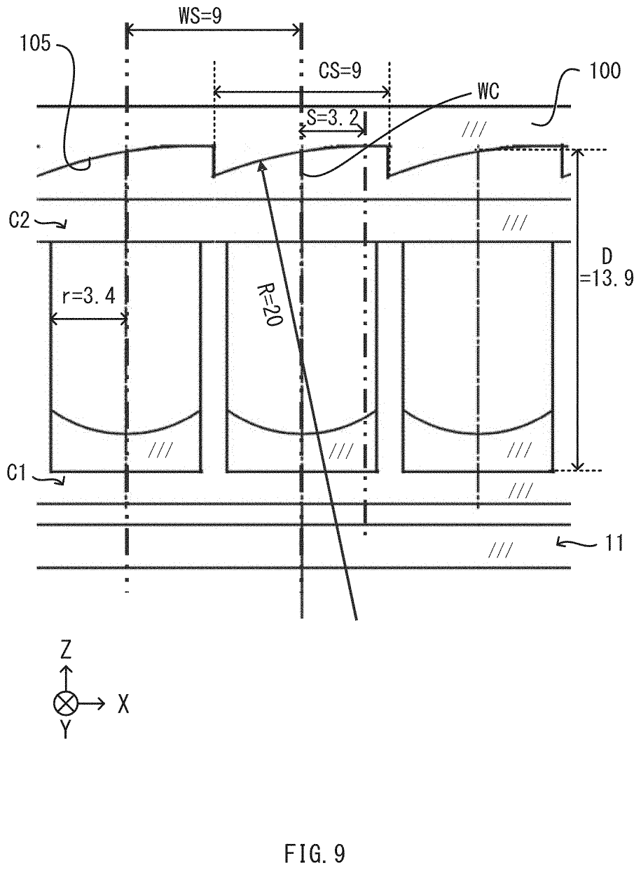

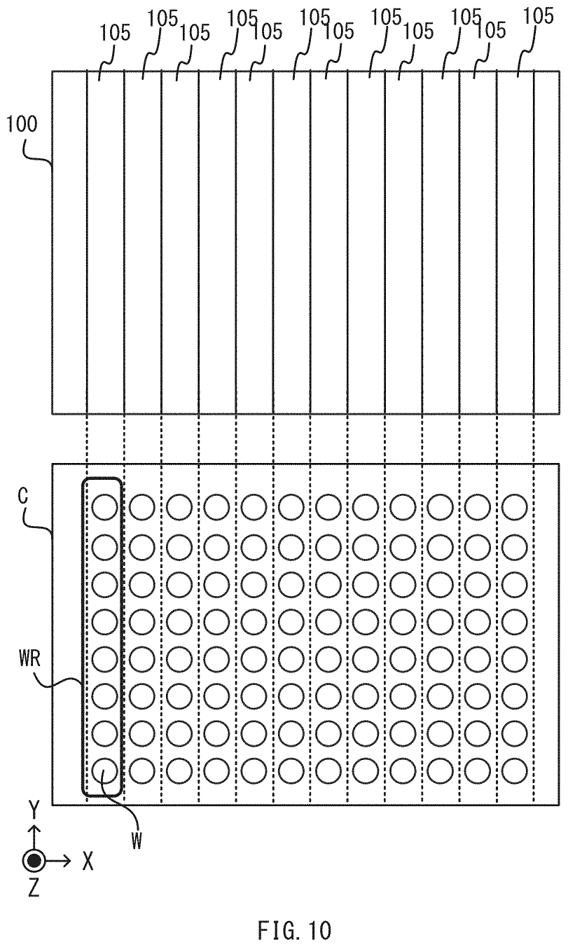

FIG. 9 is a sectional view of a reflector 100 according to the present embodiment. FIG. 10 is a diagram describing a positional relationship of the reflector and the multi-well plate. Hereinafter, the reflector 100 according to the present embodiment will be described with reference to FIG. 9 and FIG. 10.

Like the reflector 70 shown in FIG. 7, the reflector 100 is used in a state of being attached to the multi-well plate C. A well radius r and a well interval WS of the multi-well plate C are as follows. Note that the well interval WS represents a distance between the well central axes WC of the adjacent wells W.

r=34 mm, WS=9 mm

As shown in FIG. 9, the reflector 100 includes a plurality of curved surfaces 105 having a concave shape directed toward the lid C2 of the multi-well plate C. As shown in FIG. 9 and FIG. 10, the plurality of curved surfaces 105 are aligned without a gap in an X direction parallel to the bottom surface of the multi-well plate C (the vessel body C1). Thus, a width of the curved surface 105 in the X direction coincides with the well interval WS and a curved surface interval CS representing a distance between the adjacent curved surfaces 105 also coincides with the well interval WS as shown in FIG. 9.

As shown in FIG. 10, each of the plurality of curved surfaces 105 corresponds to a well row WR consisting of a plurality of the wells aligned in a Y direction orthogonal to the X direction. The reflector 100 includes the curved surfaces 105 at least as many as the number of the rows of the well rows WR and includes at least one curved surface 105 for each of the well rows WR. Note that the well row refers to a row consisting of a plurality of the wells W aligned in a certain direction among the plurality of wells W included in the multi-well plate C.

As shown in FIG. 9, the plurality of curved surfaces 105 are curved surfaces having a certain curvature. Further, each of the plurality of curved surfaces 105 is eccentric to the corresponding well row WR (the wells W). That is, a curvature center line of each of the plurality of curved surfaces 105 is deviated from the central axis of the corresponding well row WR (the wells W). The direction of the central axis of the wells W coincides with the direction of the optical axis of the observation optical system 18. A curvature radius R of the curved surface 105 and a shift amount S of the curvature center line of the curved surface 105 from the central axis of the well row are as follows.

R=20 mm, S=3.2 mm

Note that the reflector 100 is attached to the multi-well plate C such that an air conversion length D of a height from the bottom surface of the well W to the curved surface 105 is adjusted to 13.9 mm. The height from the bottom surface to the curved surface 105 is defined on the well central axis WC.

The plurality of curved surfaces 105 are reflective surfaces which reflect the light from the multi-well plate C. More specifically, the plurality of curved surfaces 105 are reflective surfaces having concave surfaces directed toward the observation optical system 18 in an observation device 10a including the reflector 100 and are reflective surfaces of front surface (first surface) mirrors. The plurality of curved surfaces 105 may be prepared by, for example, coating aluminum on a surface of a base material of the reflector 100 and forming a protective film made of an appropriate dielectric multilayer film or the like on the coated surface.

Each of the plurality of curved surfaces 105 has the positive power in the X direction. That is, it has the positive power in an XZ plane defined by the X direction and a Z direction which is the optical axis direction. Note that, as shown in FIG. 5, the X direction is a direction in which the illumination optical system 17 and the observation optical system 18 are aligned and a direction to which light is inclined with respect to the optical axis in the oblique illumination. That is, the plurality of curved surfaces 105 have power of converging light with respect to the travel direction of the oblique illumination.

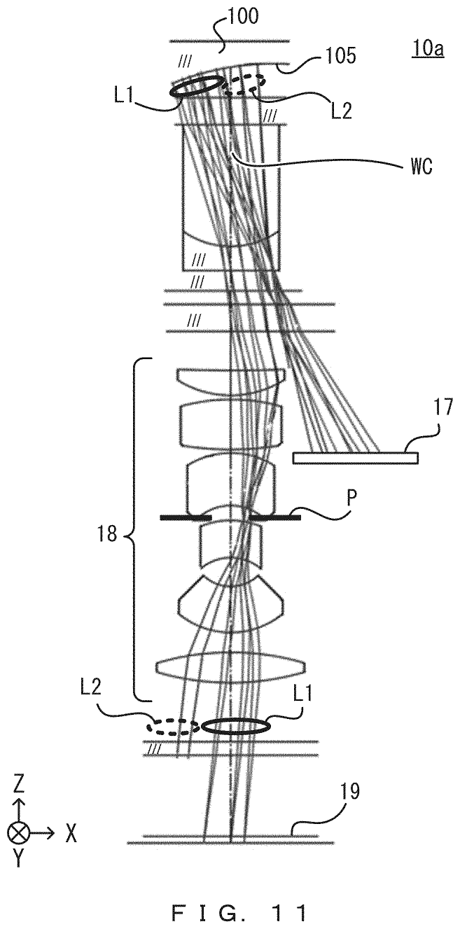

FIG. 11 is a sectional view of an observation device 10a according to the present embodiment. In FIG. 11, a light ray diagram indicating light rays traveling from the illumination optical system 17 to the imaging element 19 is superimposed on the sectional view. Note that the observation device 10a is the same as the observation device 10 except that the reflector 100 is included instead of the reflector 70.

As shown in FIG. 11, in the observation device 10a, as a part of the light emitted from the illumination optical system 17, light L1 reflected at a position further away from the illumination optical system 17 than the central axis WC of the well in the curved surface 105 enters the well bottom surface at a large incident angle corresponding to the numerical aperture of the observation optical system 18 over a wide range including the center of the well. Thus, visualization can be achieved in a wider range and with higher contrast than before. Thus, according to the reflector 100 according to the present embodiment and the observation device 10a including the reflector 100, it becomes possible to achieve the high observation performance in the observation of the phase object contained in the multi-well plate.

Note that, as a part of the light emitted from the illumination optical system 17, light L2 reflected at a position closer to the illumination optical system 17 than the central axis WC of the well in the curved surface 105 mainly irradiates a periphery or outside of a visual field. Thus, the light L2 is vignetted in the observation optical system 18 and does not reach the imaging element 19.

### Second Embodiment

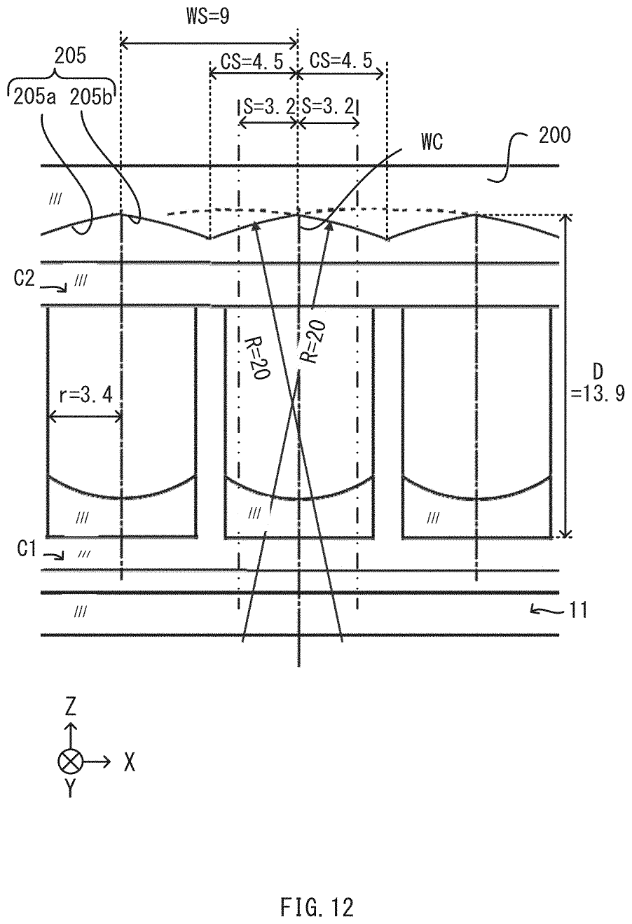

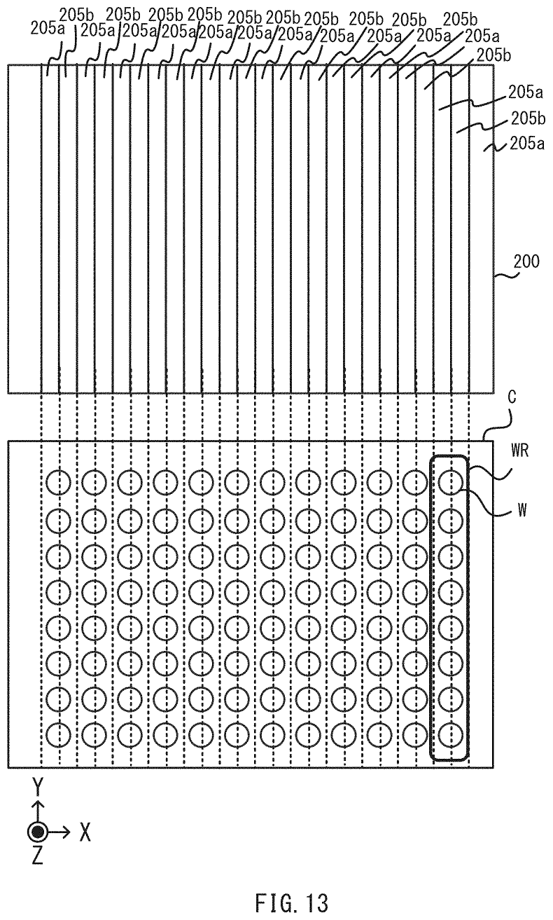

FIG. 12 is a sectional view of a reflector 200 according to the present embodiment. FIG. 13 is a diagram describing a positional relationship of the reflector and the multi-well plate. Hereinafter, the reflector 200 according to the present embodiment will be described with reference to FIG. 12 and FIG. 13.

Like the reflector 70 shown in FIG. 7, the reflector 200 is used in a state of being attached to the multi-well plate C. The well radius r and the well interval WS of the multi-well plate C are as described above in the first embodiment.

Like the reflector 100, the reflector 200 includes a plurality of curved surfaces having a concave shape directed toward the lid C2 of the multi-well plate C. However, the reflector 200 is different from the reflector 100 in that, as shown in FIG. 12 and FIG. 13, each of a plurality of curved surfaces 205 includes a pair of curved surfaces corresponding to each of the well rows WR.

Specifically, the pair of the curved surfaces included in the curved surface 205 includes a curved surface 205a having a curvature radius R of 20 mm and a curvature center line at a position shifted from the well central axis WC in an X(+) direction by 3.2 mm and a curved surface 205b having a curvature radius R of 20 mm and a curvature center line at a position shifted from the well central axis WC in an X(−) direction by 3.2 mm That is, the pair of the curved surfaces includes a first curved surface (the curved surface 205a) and a second curved surface (the curved surface 205b) symmetric with respect to the central axis WC of the well row WR.

The plurality of curved surfaces 205 are otherwise the same as the plurality of curved surfaces 105. For example, as shown in FIG. 9 and FIG. 10, like the plurality of curved surfaces 105, the plurality of curved surfaces 205 are aligned in the X direction without a gap. Thus, a distance between the curved surfaces 205 coincides with the well interval WS, and, further, a curved surface interval CS representing a distance between the curved surface 205a and the curved surface 205b adjacent to each other coincides with the half of the well interval WS.

Further, like the plurality of curved surfaces 105, the plurality of curved surfaces 205 are reflective surfaces which reflect the light from the multi-well plate C and has the positive power in the X direction. In the reflector 200, the curved surface 205a and the curved surface 205b included in the curved surface 205 each has the positive power in the multiple X directions.

In addition, the reflector 200 is the same as the reflector 100 on the point that the reflector 200 is attached to the multi-well plate C such that an air conversion length D of a height from the bottom surface of the well to the curved surface 205 is adjusted to 13.9 mm.

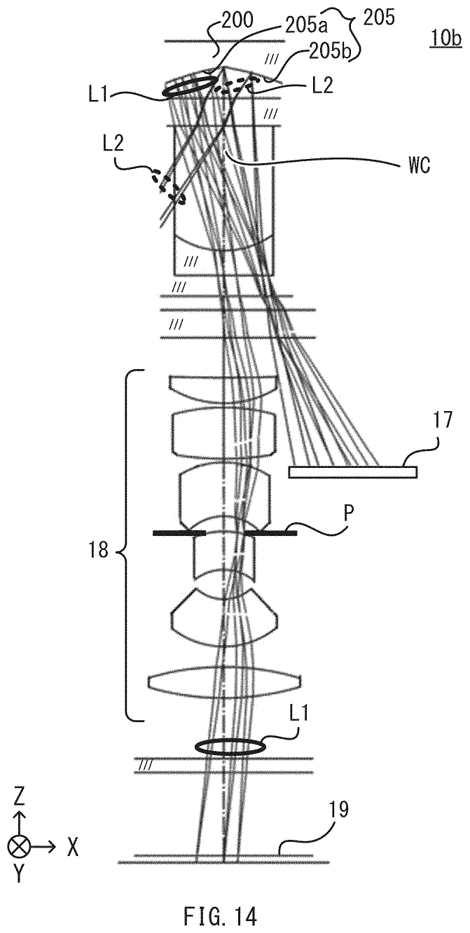

FIG. 14 is a sectional view of an observation device 10b according to the present embodiment. In FIG. 14, a light ray diagram indicating light rays traveling from the illumination optical system 17 to the imaging element 19 is superimposed on the sectional view. Note that the observation device 10b is the same as the observation device 10 except that the reflector 200 is included instead of the reflector 70.

As shown in FIG. 14, in the observation device 10b, like the observation device 10a, as a part of the light emitted from the illumination optical system 17, light L1 reflected at a position further away from the illumination optical system 17 than the central axis WC of the well (in this example, a position on the curved surface 205a) in the curved surface 205 enters the well bottom surface at a large incident angle corresponding to the numerical aperture of the observation optical system 18 over a wide range including the center of the well. Further, here again, like the observation device 10a, as a part of the light emitted from the illumination optical system 17, light L2 reflected at a position closer to the illumination optical system 17 than the central axis WC of the well (in this example, a position on the curved surface 205b) in the curved surface 205 mainly irradiates a periphery or outside of a visual field. Thus, the light L2 is vignetted in the observation optical system 18 and does not reach the imaging element 19.

Thus, as is the case for the reflector 100 according to the first embodiment and the observation device 10a, according to the reflector 200 according to the present embodiment and the observation device 10b including the reflector 200, it becomes possible to perform visualization in a wider range and with higher contrast than before and achieve the high observation performance in the observation of the phase object contained in the multi-well plate.

Note that FIG. 14 shows a case of using the illumination optical system 17 disposed on one side with respect to the optical axis (the X(+) side in this example). However, the oblique illumination symmetric with respect to the optical axis can be performed by using the illumination optical system 17 disposed on the other side with respect to the optical axis (the X(−) side in this example). Thus, according to the reflector 200 and the observation device 10b, when a plurality of the illumination optical systems 17 included in the observation device 10b are used by switching between them, it becomes possible to perform visualization in a further wider range and with further higher contrast than the case of using the reflector 100 and the observation device 10a.

### Third Embodiment

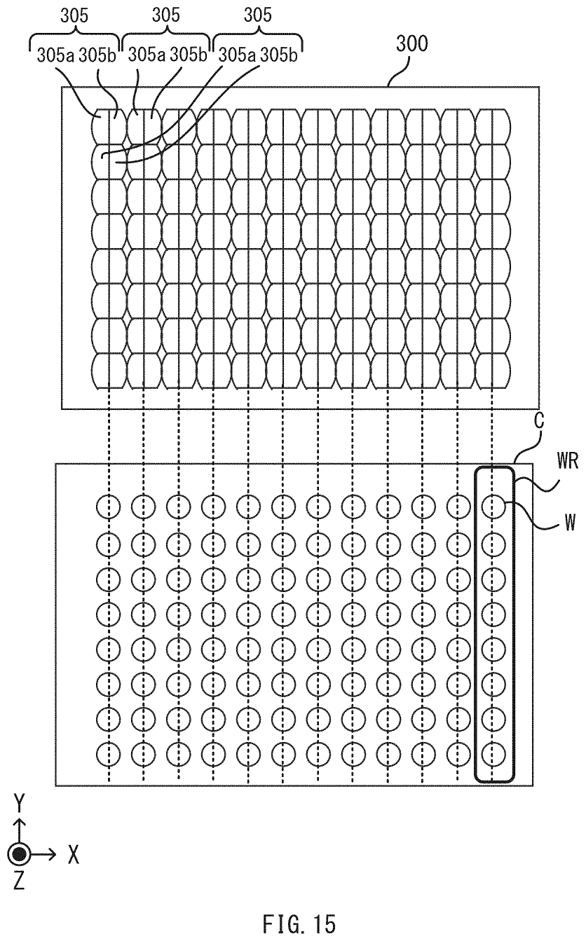

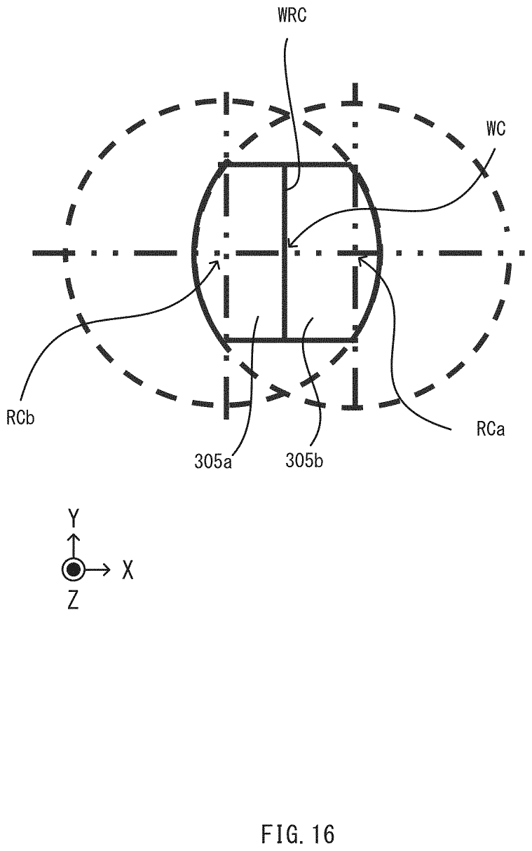

FIG. 15 is a diagram describing a positional relationship of the reflector 300 according to the present embodiment and the multi-well plate C. FIG. 16 is a diagram describing a positional relationship of the center of a well and the center of curvature of a curved surface corresponding to the well. Hereinafter, the reflector 300 according to the present embodiment will be described with reference to FIG. 15 and FIG. 16.

Like the reflector 70 shown in FIG. 7, the reflector 300 is used in a state of being attached to the multi-well plate C. This point is the same as the reflector 100 according to the first embodiment and the reflector 200 according to the second embodiment. Further, like the reflector 100 and the reflector 200, the reflector 300 includes a plurality of curved surfaces having a concave shape directed toward the lid C2 of the multi-well plate C.

The reflector 300 is different from the reflector 100 and the reflector 200 in that, as shown in FIG. 15, a plurality of curved surfaces 305 are aligned in two dimensions (the X direction and the Y direction) orthogonal to the optical axis of the observation optical system 18, and each of the plurality of curved surfaces 305 corresponds to each of the wells W.

Further, the reflector 300 is different from the reflector 100 and the reflector 200 in that, as shown in FIG. 15 and FIG. 16, each of the plurality of curved surfaces 305 includes a pair of curved surfaces corresponding to each of the wells W, and the pair of the curved surfaces include a first curved surface (a curved surface 305a) and a second curved surface (a curved surface 305b) symmetric with respect to the center of the well W (the well central axis WC). Further, the reflector 300 is different from the reflector 100 and the reflector 200 in that, unlike the curved surfaces 105 and the curved surfaces 205 which are two-dimensional curved surfaces, the curved surfaces 305 are three-dimensional curved surfaces.

However, like the reflector 100 and the reflector 200, in the reflector 300, the center of curvature of the curved surface 305 is deviated from the well central axis WC and a well row center WRC. Specifically, as shown in FIG. 16, a center of curvature RCa of the curved surface 305a is deviated from the well central axis WC in the X(+) direction and a center of curvature RCb of the curved surface 305b is deviated from the well central axis WC in the X(−) direction.

Further, the curved surface 305a and the curved surface 305b included in the curved surface 305 is each a spherical surface and has power in the Y direction in addition to the X direction. That is, it has the positive power in a YZ plane in addition to the XZ plane defined by the X direction and a Z direction which is the optical axis direction. Further, in other words, the plurality of curved surfaces 305 have power of converging light in a direction orthogonal to the travel direction of the oblique illumination in addition to the power of converging light in the travel direction of the oblique illumination.

The reflector 300 according to the present embodiment and the observation device including the reflector 300 make it possible to expand a range where the oblique illumination is established also in the direction orthogonal to the oblique illumination. Thus, it becomes possible to perform visualization in a further wider range and with further higher contrast as compares with the cases in the first embodiment and the second embodiment and achieve the high observation performance in the observation of the phase object contained in the multi-well plate.

### Fourth Embodiment

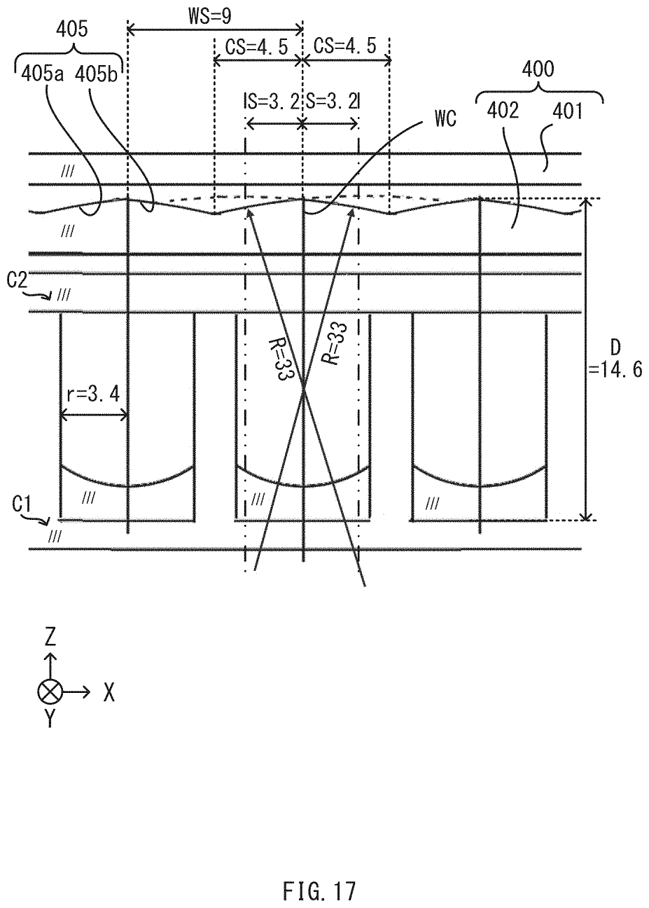

FIG. 17 is a sectional view of a reflector 400 according to the present embodiment. Hereinafter, the reflector 400 according to the present embodiment will be described with reference to FIG. 17.

Like the reflector 70 shown in FIG. 7, the reflector 400 is used in a state of being attached to the multi-well plate C. The well radius r and the well interval WS of the multi-well plate C are as described above in the first embodiment.

Like the reflector 200, the reflector 400 includes a plurality of curved surfaces having a concave shape with respect to the incident light. Further, like the reflector 200, each of a plurality of curved surfaces 405 included in the reflector 400 includes a pair of curved surfaces (a curved surface 405a and a curved surface 405b) corresponding to each of the well rows WR. However, the reflector 400 is different from the reflector 200 in that, as shown in FIG. 17, the plurality of curved surfaces 405 are reflective surfaces of back surface (second surface) mirrors.

More specifically, as shown in FIG. 17, the reflector 400 includes a base 401 and an optical element 402. The optical element 402 is a back surface mirror having a flat surface directed toward the lid C2 of the multi-well plate C, and a reflective surface is formed on a convex surface directed toward the base 401. That is, the reflective surface is the reflective surface of the back surface mirror and acts as a concave mirror having the positive power in the X direction to the incident light. Further, the base 401 functions as a protective cover disposed so as to face the reflective surface of the back surface mirror.

Note that, in the reflector 400, the shift amount S (=3.2 mm) of the curved surface 405 from the central axis WC of the well row is the same as the shift amount in the reflector 200. However, the curvature radius R (=33 mm) of the curved surface 405 is different from the curvature radius in the reflector 200. Thus, the air conversion length D of the height from the bottom surface of the well to the curved surface 405 is different from the height in the reflector 200.

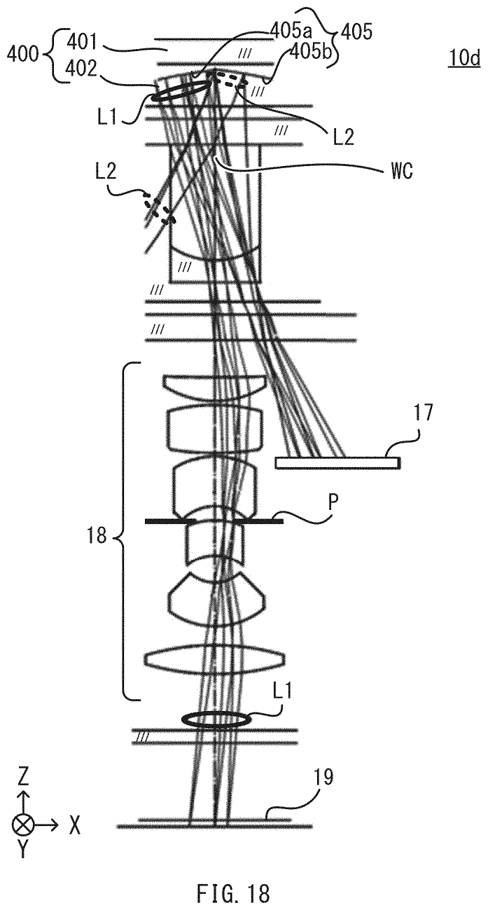

FIG. 18 is a sectional view of an observation device 10d according to the present embodiment. In FIG. 18, a light ray diagram indicating light rays traveling from the illumination optical system 17 to the imaging element 19 is superimposed on the sectional view. Note that the observation device 10d is the same as the observation device 10 except that the reflector 400 is included instead of the reflector 70.

As shown in FIG. 18, the light rays travel in an observation device 10d in the substantially same manner as in the observation device 10b according to the second embodiment. That is, as a part of the light emitted from the illumination optical system 17, light L1 reflected at a position further away from the illumination optical system 17 than the central axis WC of the well (in this example, a position on the curved surface 405a) in the curved surface 405 enters the well bottom surface at a large incident angle corresponding to the numerical aperture of the observation optical system 18 over a wide range including the center of the well. On the other hand, as a part of the light emitted from the illumination optical system 17, light L2 reflected at a position closer to the illumination optical system 17 than the central axis WC of the well (in this example, a position on the curved surface 405b) in the curved surface 405 mainly irradiates a periphery or outside of a visual field. Thus, the light L2 is vignetted in the observation optical system 18 and does not reach the imaging element 19. Further, the oblique illumination symmetric with respect to the optical axis can be performed by switching between the illumination optical systems 17 to be used.

Thus, like the reflector 200 and the observation device 10b, the reflector 400 and the observation device 10d also make it possible to perform visualization in a wider range and with higher contrast as compares with the case of using the reflector 100 and the observation device 10a. Further, in the reflector 400, the curved surface 405 is protected by the base 401 and is not exposed to the outside. Thus, it becomes possible to avoid, for example, a situation where a damage caused to the reflective surface deteriorates the performance.

### Fifth Embodiment

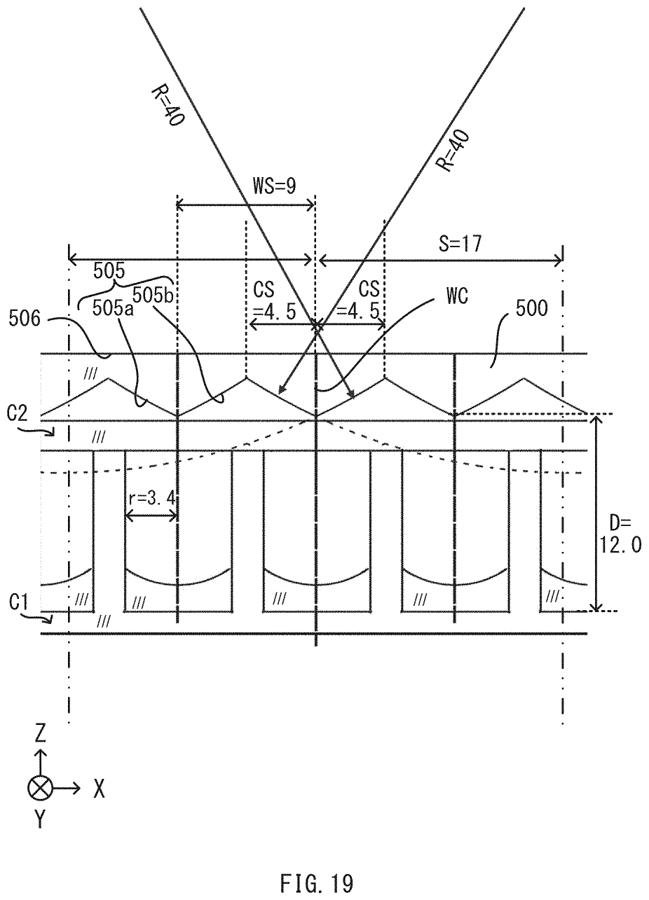

FIG. 19 is a sectional view of a reflector 500 according to the present embodiment. Hereinafter, the reflector 500 according to the present embodiment will be described with reference to FIG. 19.

Like the reflector 70 shown in FIG. 7, the reflector 500 is used in a state of being attached to the multi-well plate C. The well radius r and the well interval WS of the multi-well plate C are as described above in the first embodiment.

Like the reflector 200, the reflector 500 includes a plurality of curved surfaces having the positive power. Further, like the reflector 200, each of a plurality of curved surfaces 505 included in the reflector 500 includes a pair of curved surfaces (a curved surface 505a and a curved surface 505b) corresponding to each of the well rows WR. However, the reflector 500 is different from the reflector 200 in that, as shown in FIG. 19, the plurality of curved surfaces 505 are configured as convex surfaces with respect to the incident light and the plurality of curved surfaces 505 are not the reflective surfaces, but refractive surfaces.

More specifically, as shown in FIG. 19, the reflector 500 includes a curved surface 505 on the side of the lid C2 of the multi-well plate C and a reflective surface 506 having a planar shape on a back surface. The curved surface 505 is a refractive surface having a convex shape and has the positive power in the X direction.

Note that, in the reflector 500, the curvature radius R of the curved surface 505 (a curved surface 505a and a curved surface 505b) and the shift amount S of the curved surface 505 (the curved surface 505a and the curved surface 505b) from the central axis WC of the well row are as follows.

R=40 mm, S=17 mm

Further, the air conversion length D of the height from the bottom surface of the well to the curved surface 505 is as follows.

D=12.0 mm

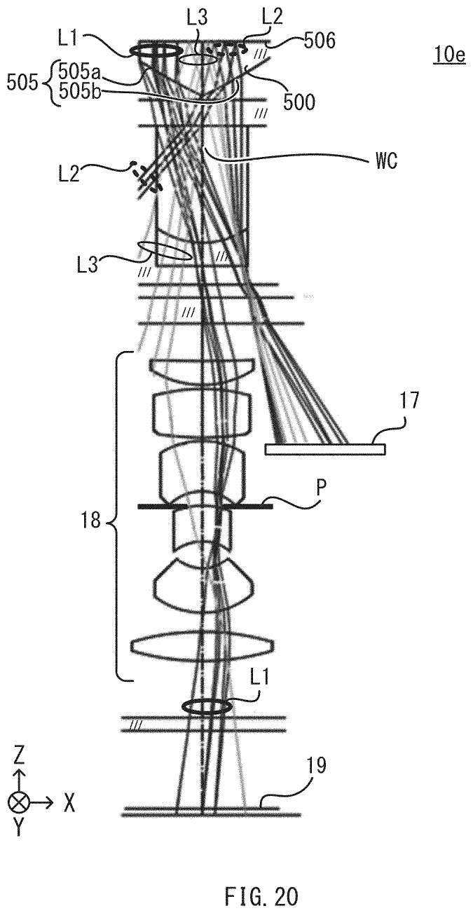

FIG. 20 is a sectional view of an observation device 10e according to the present embodiment. In FIG. 20, a light ray diagram indicating light rays traveling from the illumination optical system 17 to the imaging element 19 is superimposed on the sectional view. Note that the observation device 10e is the same as the observation device 10 except that the reflector 500 is included instead of the reflector 70.

As shown in FIG. 20, in the observation device 10e, as a part of the light emitted from the illumination optical system 17, the light L1, which enters the curved surface (the curved surface 505a in this example) further away from the illumination optical system 17 than the center of the well in the curved surface 505 and exits from the same curved surface, enters the well bottom surface at a large incident angle corresponding to the numerical aperture of the observation optical system 18 over a wide range including the center of the well. On the other hand, as a part of the light emitted from the illumination optical system 17, the light L2, which enters the curved surface (the curved surface 505b in this example) closer to the illumination optical system 17 than the center of the well in the curved surface 505 and exits from the same curved surface, mainly irradiates a periphery or outside of a visual field. Thus, the light L2 is vignetted in the observation optical system 18 and does not reach the imaging element 19. Further, light (e.g., light L3), which enters and exits from the reflector 500 through the different curved surfaces, is mostly vignetted in the observation optical system 18 and does not reach the imaging element 19. Further, the oblique illumination symmetric with respect to the optical axis can be performed by switching between the illumination optical systems 17 to be used.

Thus, like the reflector 200 and the observation device 10b, the reflector 500 and the observation device 10e also make it possible to perform visualization in a wider range and with higher contrast as compares with the case of using the reflector 100 and the observation device 10a.

### Sixth Embodiment

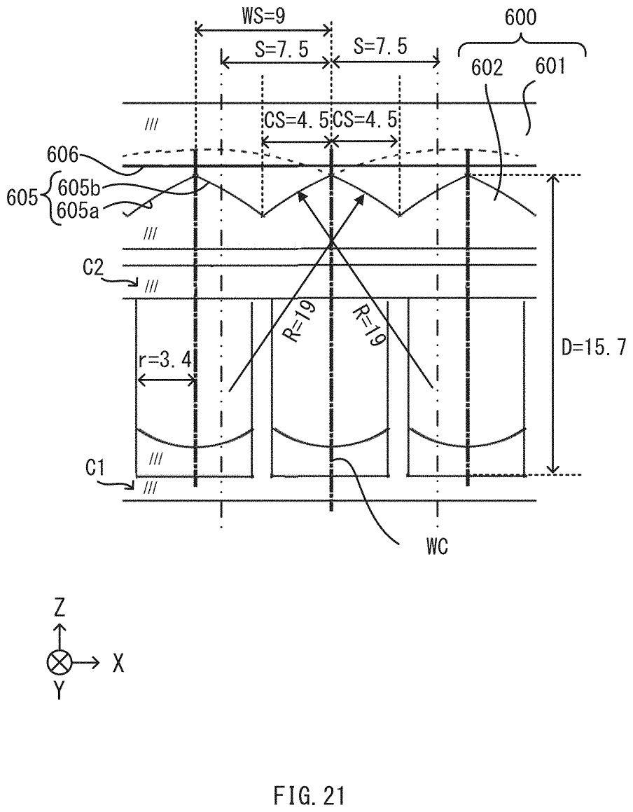

FIG. 21 is a sectional view of a reflector 600 according to the present embodiment. Hereinafter, the reflector 600 according to the present embodiment will be described with reference to FIG. 21.

Like the reflector 70 shown in FIG. 7, the reflector 600 is used in a state of being attached to the multi-well plate C. The well radius r and the well interval WS of the multi-well plate C are as described above in the first embodiment.

Like the reflector 500, the reflector 600 includes a plurality of curved surfaces having the positive power. Further, like the reflector 500, each of a plurality of curved surfaces 605 included in the reflector 600 includes a pair of curved surfaces (a curved surface 605a and a curved surface 605b) corresponding to each of the well rows WR. Further, like the reflector 500, in the reflector 600, the plurality of curved surfaces 605 are the refractive surfaces as shown in FIG. 21.

The reflector 600 includes a base 601 and an optical element 602, and a reflective surface 606 is disposed in the base 601 and a curved surface 605 is disposed in the optical element 602. That is, the reflector 600 is different from the reflector 500 in that the reflective surface 606 and the curved surface 605 which is the refractive surface having the positive power in the X direction are separately disposed in the different members.

Note that, in the reflector 600, the curvature radius R of the curved surface 605 (a curved surface 605a and a curved surface 605b) and the shift amount S of the curved surface 605 (the curved surface 605a and the curved surface 605b) from the central axis WC of the well row are as follows.

R=19 mm, S=7.5 mm

Further, the air conversion length D of the height from the bottom surface of the well to the curved surface 605 is as follows.

D=15.7 mm

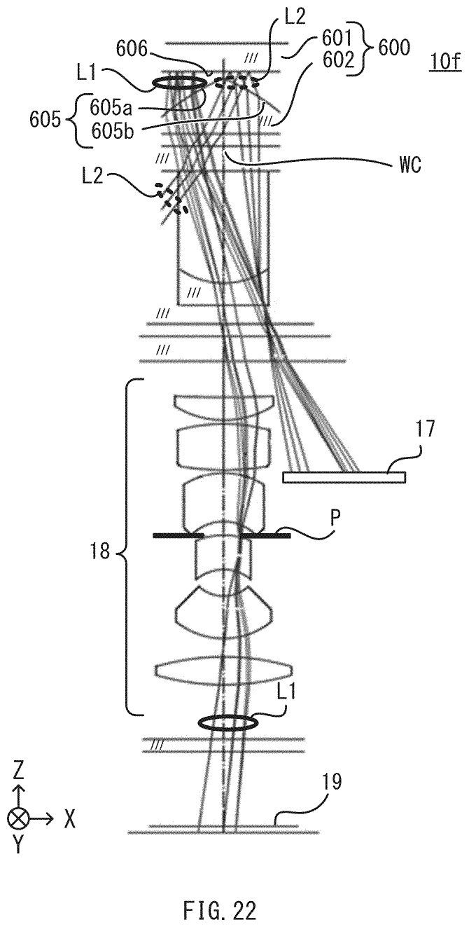

FIG. 22 is a sectional view of an observation device 10f according to the present embodiment. In FIG. 22, a light ray diagram indicating light rays traveling from the illumination optical system 17 to the imaging element 19 is superimposed on the sectional view. Note that the observation device 10f is the same as the observation device 10 except that the reflector 600 is included instead of the reflector 70.

As shown in FIG. 22, in the observation device 10f, as a part of the light emitted from the illumination optical system 17, the light L1, which exits from the curved surface (the curved surface 605a in this example) further away from the illumination optical system 17 than the central axis WC of the well and enters the same curved surface, enters the well bottom surface at a large incident angle corresponding to the numerical aperture of the observation optical system 18 over a wide range including the center of the well. On the other hand, as a part of the light emitted from the illumination optical system 17, the light L2, which exits from the curved surface (the curved surface 605b in this example) closer to the illumination optical system 17 than the central axis WC of the well and enters the same curved surface, mainly irradiates a periphery or outside of a visual field. Thus, the light L2 is vignetted in the observation optical system 18 and does not reach the imaging element 19. Note that the base 601 and the optical element 602 are closely arranged to each other in the reflector 600, thus there is almost no light which exits from and enters the optical element 602 through the different curved surfaces. Further, the oblique illumination symmetric with respect to the optical axis can be performed by switching between the illumination optical systems 17 to be used.

Thus, like the reflector 500 and the observation device 10e, the reflector 600 and the observation device 10f also make it possible to perform visualization in a wider range and with higher contrast as compares with the case of using the reflector 100 and the observation device 10a.

Finally, design conditions desirably satisfied by the reflector will be described. The above reflectors according to the embodiments can exhibit the above effects to the maximum by properly designing the positive power and the shift amount of the curved surface from the well center (or the well row center).

In the case where the reflective surface in the reflector has the positive power as described in the first embodiment and the fourth embodiment, the reflector desirably satisfies the following conditional formula (1) and the conditional formula (2).

0.3<(Rₘᵢᵣᵣₒᵣ/nₘᵢᵣᵣₒᵣ)/(10 sin h(0.4R_{well})+h)<1 (1)

Yₘᵢᵣᵣₒᵣ(NA²+nₘᵢᵣᵣₒᵣ²)^{1/2}/(NA(Rₘᵢᵣᵣₒᵣ−h))>1 (2)

In this formula, Rₘᵢᵣᵣₒᵣ represents the curvature radius of the reflective surface. nₘᵢᵣᵣₒᵣ represents the refractive index of the medium of the reflective surface on the incident side. In other words, nₘᵢᵣᵣₒᵣ represents the refraction index of the medium on the incident side with respect to the reflecting surface. R_{well} represents the radius of the well of the multi-well plate. h represents the air conversion length of the height from the sample surface (the well bottom surface) to the reflective surface at the well center. Yₘᵢᵣᵣₒᵣ represents the shift amount of the center of curvature of the reflective surface with respect to the well center in the lateral direction (the Y direction). NA represents the numerical aperture of the observation optical system on the object side.

Note that, since it is obvious that each variable in the conditional formula (2) is a positive value, the conditional formula (2) can be rewritten into the following conditional formula (2′)

0<(NA(Rₘᵢᵣᵣₒᵣ−h))/Yₘᵢᵣᵣₒᵣ(NA²+nₘᵢᵣᵣₒᵣ²)^{1/2}<1 (2′)

Further, in the case where the refractive surface in the reflector has the positive power as described in the fifth embodiment and the sixth embodiment, the reflector desirably satisfies the following conditional formula (3) and the conditional formula (4).

0.3<Rₗₑₙₛ/(nₗₑₙₛ−1)/(10 sin h(0.4R_{well})+h)<1.5 (3)

Yₗₑₙₛ(nₗₑₙₛ−1)/(NA(Rₗₑₙₛ−h))>1 (4)

In the formulae, Rₗₑₙₛ represents the curvature radius of the refractive surface. nₗₑₙₛ represents the refractive index of the optical element having the refractive surface. R_{well} represents the radius of the well of the multi-well plate. h represents the air conversion length of the height from the sample surface (the well bottom surface) to the refractive surface at the well center. Yₗₑₙₛ represents the shift amount of the center of curvature of the refractive surface with respect to the well center in the lateral direction (the Y direction). NA represents the numerical aperture of the observation optical system on the object side.

Note that, since it is obvious that each variable in the conditional formula (4) is a positive value, the conditional formula (4) can be rewritten into the following conditional formula (4′)

0<(NA(Rₗₑₙₛ−h))/Yₗₑₙₛ(Nₗₑₙₛ−1)<1 (4′)

A medium surface (a liquid surface in the well), which forms a concave surface by surface tension, causes the illumination light to be refracted and spread on the medium surface. The illumination light is desirably prevented from being excessively spread by making correction by means of the positive power of the reflective surface (the refractive surface). The conditional formula (1) and the conditional formula (3) are formulae that define an appropriate range of the correction amount on the reflective surface (the refractive surface). Note that the concave shape on the medium surface changes depending on the diameter of the well, and the effect of spreading the illumination light becomes stronger as the well diameter becomes smaller. Further, the positive power of the reflective surface (the refractive surface) depends on the curvature radius of the reflective surface (the refractive surface) and the refractive index of the medium.

Satisfying the conditional formula (1) (or the conditional formula (3)) can uniformize the incident angle of the illumination light which enters the sample and travels toward the observation optical system 18 at each position in the well. When the conditional formula (1) (or the conditional formula (3)) gives a lower limit value (0.3) or less, the correction amount by the positive power becomes too large, and the illumination light is excessively converged. As a result, the incident angle of the illumination light becomes too small at a position closer to the illumination optical system 17 in the well, while the incident angle of the illumination light becomes too large at a position further from the illumination optical system 17 in the well. Thus, uniformity of the incident angle is deteriorated. On the other hand, when the conditional formula (1) (or the conditional formula (3)) gives an upper limit value (1 (or 1.5)) or more, the correction amount by the positive power becomes too small, and the illumination light is excessively spread. As a result, the incident angle of the illumination light becomes too large at the position closer to the illumination optical system 17 in the well, while the incident angle of the illumination light becomes too small at the position further from the illumination optical system 17 in the well. Thus, uniformity of the incident angle is deteriorated.

The conditional formula (2) (or the conditional formula (4)) is a formula that defines conditions for establishing the oblique illumination. After the uniformity of the incident angle of the illumination light in the well is confirmed by satisfying the conditional formula (1) (or the conditional formula (3)), the oblique illumination can be established in a wide range in the well by satisfying the conditional formula (2) (or the conditional formula (4)). Although the conditional formula (1) (or the conditional formula (3)) is satisfied, if the conditional formula (2) (or the conditional formula (4)) is not satisfied by having too small shift amount, the incident angle becomes too small with respect to the numerical aperture of the observation optical system 18. This prevents the oblique illumination from being established and makes it difficult to observe the phase object with good contrast.

Any of the above reflectors according to the embodiments satisfy the above conditional formulae as described below. Note that the result of the third embodiment is the same as that of the second embodiment.

<Reflector 100 According to First Embodiment>

NA=0.25

R_{well}=3.4 mm

h=13.9 mm

Rₘᵢᵣᵣₒᵣ=20 mm

Yₘᵢᵣᵣₒᵣ=3.2 mm

nₘᵢᵣᵣₒᵣ=1

(1)(Rₘᵢᵣᵣₒᵣ/nₘᵢᵣᵣₒᵣ)/(10 sin h(0.4R_{well})+h)=0.62

(2)Yₘᵢᵣᵣₒᵣ(NA²+nₘᵢᵣᵣₒᵣ²)^{1/2}/(NA(Rₘᵢᵣᵣₒᵣ−h))=2.16

<Reflector 200 According to Second Embodiment>

NA=0.25

R_{well}=3.4 mm

h=13.9 mm

Rₘᵢᵣᵣₒᵣ=20 mm

Yₘᵢᵣᵣₒᵣ=3.2 mm

nₘᵢᵣᵣₒᵣ=1

(1)(Rₘᵢᵣᵣₒᵣ/nₘᵢᵣᵣₒᵣ)/(10 sin h(0.4R_{well})+h)=0.62

(2)Yₘᵢᵣᵣₒᵣ(NA²+nₘᵢᵣᵣₒᵣ²)^{1/2}/(NA(Rₘᵢᵣᵣₒᵣ−h))=2.16

<Reflector 400 According to Fourth Embodiment>

NA=0.25

R_{well}=3.4 mm

h=14.6 mm

Rₘᵢᵣᵣₒᵣ=33 mm

Yₘᵢᵣᵣₒᵣ=3.2 mm

nₘᵢᵣᵣₒᵣ=1.491

(1)(Rₘᵢᵣᵣₒᵣ/nₘᵢᵣᵣₒᵣ)/(10 sin h(0.4R_{well})+h)=0.62

(2)Yₘᵢᵣᵣₒᵣ(NA²+nₘᵢᵣᵣₒᵣ²)^{1/2}/(NA(Rₘᵢᵣᵣₒᵣ−h))=1.05

<Reflector 500 According to Fifth Embodiment>

NA=0.25

R_{well}=3.4 mm

h=12.0 mm

Rₗₑₙₛ=40 mm

Yₗₑₙₛ=17 mm

nₗₑₙₛ=1.491

(3)Rₗₑₙₛ/(nₗₑₙₛ−1)/(10 sin h(0.4R_{well})+h)=1.15

(4)Yₗₑₙₛ(nₗₑₙₛ−1)/(NA(Rₗₑₙₛ−h))=1.19

<Reflector 600 According to Sixth Embodiment>

NA=0.25

R_{well}=3.4 mm

h=15.7 mm

Rₗₑₙₛ=19 mm

Yₗₑₙₛ=7.5 mm

nₗₑₙₛ=1.491

(3)Rₗₑₙₛ/(nₗₑₙₛ−1)/(10 sin h(0.4R_{well})+h)=1.15

(4)Yₗₑₙₛ(nₗₑₙₛ−1)/(NA(Rₗₑₙₛ−h))=1.19

The above embodiments are specific examples for facilitating the understanding of the invention, and the present invention is not limited to these embodiments. Modifications obtained by modifying the above embodiments and alternative forms replacing the above embodiments can be included. That is, in each embodiment, the constituent elements can be modified without departing from the spirit and the scope thereof. Further, a new embodiment can be implemented by appropriately combining the multiple constituent elements disclosed in one or more of the embodiments. Further, some constituent elements may be omitted from the constituent elements described in the corresponding embodiment, or some constituent elements may be added to the constituent elements described in the embodiment. Further, the order of the processing procedures in each embodiment is interchangeable as long as there is no contradiction. That is, the observation device and the reflector of the present invention can be variously modified and changed without departing from the scope of the invention defined by the claims.

The reflective surfaces of the reflectors according to the first embodiment and the fourth embodiment may be configured as three-dimensional curved surfaces. In this case, the same effects as those of the reflector according to the third embodiment can be obtained. Further, the refractive surfaces of the reflectors according to the fifth embodiment and the sixth embodiment may be configured as the three-dimensional curved surfaces, and, for example, a fly-eye lens may be used. Also, in this case, the same effects as those of the reflector according to the third embodiment can be obtained. Further, the curved surface according to each of the embodiments may be divided into multiple parts and formed in a step-like shape like a Fresnel surface of a Fresnel lens. In this manner, the reflector can be made further thinner.

What is claimed is:

1. An observation device comprising:
an illumination optical system provided on a lower side of an installation position of a multi-well plate;
a reflector that reflects light emitted from the illumination optical system, the reflector being provided on an upper side of the installation position; and
an observation optical system that condenses the light reflected by the reflector, the observation optical system being provided on the lower side of the installation position,
wherein the reflector includes a plurality of curved surfaces where the light emitted from the illumination optical system enters,
wherein each of the plurality of curved surfaces:
corresponds to one or more wells included in the multi-well plate;
has positive power in a first direction in which the illumination optical system and the observation optical system are aligned; and
has a center of curvature at a position deviating from a central axis of a well of the multi-well plate.

2. The observation device according to claim 1,
wherein:
the plurality of curved surfaces are aligned in the first direction; and
each of the plurality of curved surfaces corresponds to a well row consisting of a plurality of wells aligned in a second direction intersecting with the first direction, the well row being included in the multi-well plate.

3. The observation device according to claim 2,
wherein the plurality of curved surfaces each includes a pair of curved surfaces corresponding to each of the well rows,
wherein the pair of the curved surfaces include a first curved surface and a second curved surface symmetric with respect to the central axis of the well row.

4. The observation device according to claim 1,
wherein:
the plurality of curved surfaces are aligned in two dimensions orthogonal to the central axis of the well of the multi-well plate; and
each of the plurality of curved surfaces corresponds to the well included in the multi-well plate.

5. The observation device according to claim 4,
wherein the plurality of curved surfaces each includes a pair of the curved surfaces corresponding to each of the wells,
wherein the pair of curved surfaces include the first curved surface and the second curved surface symmetric with respect to the center of the well.

6. The observation device according to claim 1,
wherein each of the plurality of curved surfaces is a reflective surface having a concave surface directed toward the observation optical system.

7. The observation device according to claim 2,
wherein each of the plurality of curved surfaces is a reflective surface having a concave surface directed toward the observation optical system.

8. The observation device according to claim 3,
wherein each of the plurality of curved surfaces is a reflective surface having a concave surface directed toward the observation optical system.

9. The observation device according to claim 4,
wherein each of the plurality of curved surfaces is a reflective surface having a concave surface directed toward the observation optical system.

10. The observation device according to claim 5,
wherein each of the plurality of curved surfaces is a reflective surface having a concave surface directed toward the observation optical system.

11. The observation device according to claim 6,
wherein each of the plurality of curved surfaces is the reflective surface of a back surface mirror.

12. The observation device according to claim 7,
wherein each of the plurality of curved surfaces is the reflective surface of a back surface mirror.

13. The observation device according to claim 11,
wherein the reflector further includes a protective cover disposed so as to face the reflective surface of the back surface mirror.

14. The observation device according to claim 6,
wherein each of the plurality of curved surfaces is the reflective surface of a front surface mirror.

15. The observation device according to claim 6,
wherein the reflector satisfies following conditional formulae:
0.3<(Rₘᵢᵣᵣₒᵣ/nₘᵢᵣᵣₒᵣ)/(10 sin h(0.4R_{well})+h)<1 (1)
Yₘᵢᵣᵣₒᵣ(NA²+nₘᵢᵣᵣₒᵣ²)^{1/2}/(NA(Rₘᵢᵣᵣₒᵣ−h))>1 (2)
wherein Rₘᵢᵣᵣₒᵣ represents a curvature radius of the reflective surface, nₘᵢᵣᵣₒᵣ represents a refractive index of a medium of the reflective surface on an incident side, R_{well} represents a radius of the well of the multi-well plate, h represents an air conversion length of a height from a well bottom surface of the well to the reflective surface in a well center, Yₘᵢᵣᵣₒᵣ represents a shift amount of the center of curvature of the reflective surface with respect to the center of the well in the first direction, and NA represents a numerical aperture of the observation optical system on an object side.

16. The observation device according to claim 1, wherein:
the reflector includes,
from a side of the observation optical system:
a refractive surface having the positive power; and
the reflective surface; and
each of the plurality of curved surfaces is the refractive surface.

17. The observation device according to claim 16,
wherein the reflector satisfies the following conditional formulae:
0.3<Rₗₑₙₛ/(nₗₑₙₛ−1)/(10 sin h(0.4R_{well})+h)<1.5 (3)
Yₗₑₙₛ(nₗₑₙₛ−1)/(NA(Rₗₑₙₛ−h))>1 (4)
wherein Rₗₑₙₛ represents the curvature radius of the refractive surface, nₗₑₙₛ represents the refractive index of the optical element having the refractive surface, R_{well} represents the radius of the well of the multi-well plate, h represents the air conversion length of the height from the bottom surface of the well to the refractive surface at the center of the well, Yₗₑₙₛ represents the shift amount of the center of curvature of the refractive surface with respect to the center of the well in the first direction, and NA represents the numerical aperture of the observation optical system on the object side.

18. The observation device according to claim 1,
wherein the reflector further includes a positioning structure that positions the reflector to a predetermined position with respect to the multi-well plate.

19. A reflector attached to a multi-well plate, comprising:
a positioning structure that positions the reflector placed so as to cover an upper surface of the multi-well plate to a predetermined position with respect to the multi-well plate; and
a plurality of curved surfaces where light from the multi-well plate enters, wherein each of the plurality of curved surfaces:
is configured to correspond to one or more wells included in the multi-well plate;
has positive power; and
has a center of curvature at a position deviating from any of centers of the corresponding one or more wells.

20. A method for observing a phase object contained in a multi-well plate comprising:
emitting light from an illumination optical system provided on a lower side of an installation position of the multi-well plate;
reflecting the light emitted from the illumination optical system by a reflector provided on an upper side of the installation position; and
condensing the light reflected by the reflector by an observation optical system provided on the lower side of the installation position,
wherein the reflector has a plurality of curved surfaces where the light emitted from the illumination optical system enters,
wherein each of the plurality of curved surfaces:
corresponds to one or more wells included in the multi-well plate;
has positive power in a first direction in which the illumination optical system and the observation optical system are aligned; and
has a center of curvature at a position deviating from a central axis of a well of the multi-well plate.
